(19) United States
(12) Patent Application Publication
(10) Pub. No.: US 2025/0303595 A1
(43) Pub. Date: Oct. 2, 2025

(54) RETRACTABLE RAZOR

(71) Applicant: The Gillette Company LLC, Boston, MA (US)

(72) Inventor: Ashley Kim Wojtaszek, Dorchester, MA (US)

(21) Appl. No.: 18/617,361

(22) Filed: Mar. 26, 2024

(51) Int. Cl. B26B 21/40; B26B 21/52

(52) U.S. Cl. CPC B26B 21/4037; B26B 21/4012; B26B 21/523

(57) ABSTRACT

A retractable razor. The retractable razor includes a leaf spring assembly, a rail, and a shaving razor cartridge. The leaf spring assembly has a first leaf spring and a second leaf spring mounted to a housing. The rail is slidably mounted to the housing and has a tab. The shaving razor cartridge is rotationally mounted to the rail. The shaving razor cartridge is configured to move relative to the housing between a retracted position and an open position. The tab is positioned at a first end of the leaf spring assembly in the retracted position and at a second end of the leaf spring assembly in the open position.

### FIELD OF THE INVENTION

The present invention relates to a razor and more particularly to a retractable razor.

### BACKGROUND OF THE INVENTION

Most razors available to consumers include a head or razor cartridge having one or more exposed blades. However, when not in use, storage of these razors can provide hazards where a user can be cut by the blades if the razor is handled incorrectly and travel with these razors can contaminate and/or damage the blades. Some razors have incorporated a separate cap/cover that can be positioned on the head/razor cartridge to cover the blades and protect the blades from contamination and/or damage during storage and/or travel. However, this requires an extra part that increases the expense of the razor and can be damaged and/or lost. Other razors have attempted to protect the blades by allowing the blades to be positioned within another portion of the razor to protect the blades when the razor is not in use. However, these razors are complicated and expensive and required multiple steps and two hands to attempt to get the razor from a position of use to a position of storage.

Therefore, a razor is needed that can be switched from an open, or use, position to a storage position, where the blades are not exposed, simply and easily and preferably, using only one hand.

### SUMMARY OF THE INVENTION

The present invention relates to a retractable razor. In one implementation, the retractable razor comprises a leaf spring assembly, a rail, and a shaving razor cartridge. The leaf spring assembly has a first leaf spring and a second leaf spring mounted to a housing. The rail is slidably mounted to the housing and has a tab. The shaving razor cartridge is rotationally mounted to the rail and is configured to move relative to the housing between a retracted position and an open position. The tab is positioned at a first end of the leaf spring assembly in the retracted position and at a second end of the leaf spring assembly in the open position.

First ends of the first and second leaf springs can be rotatably fixed at a first end of the housing.

Second ends of the first and second leaf springs can be positioned within elongated recesses at a second end of the housing.

The tab can be circular.

A top surface of the rail opposite the tab can include a button configured to receive a digit of a user.

The first leaf spring can have a convex surface facing a convex surface of the second leaf spring.

The housing can define an elongated slot dimensioned to receive the tab.

The tab can be secured between a first end of the first leaf spring, a first end of the second leaf spring, and a first end of the elongated slot in the housing, in the retracted position.

The tab can be secured between a second end of the first spring, a second end of the second leaf spring, and a second end of the elongated slot in the housing, in the open position.

The shaving razor can include a handle defining a cavity configured to receive the leaf spring assembly and the rail.

The shaving razor cartridge can include a disc positioned within a circular opening defined by the rail.

The tab can be configured to push the first and second leaf springs apart when moved between the retracted position and the open position.

In another implementation, the retractable razor comprises a housing, a rail, a button, a shaving razor cartridge, and a linkage. The rail is slidably mounted to the housing and defines a circular opening. The button is slidably mounted to the rail. The shaving razor cartridge has a disc rotationally mounted within the circular opening. The linkage has a first end pivotably coupled to the disc and a second end pivotably coupled to the button and is configured to rotate the disc relative to the rail.

The disc can be fixed to the shaving razor cartridge.

The button can have a forward position with the shaving razor cartridge positioned non-parallel to the rail.

The button can have a rearward position with the shaving razor cartridge positioned parallel to the rail.

In another implementation, the retractable razor comprises a leaf spring assembly, a rail, a button, a shaving razor cartridge, and a linkage. The leaf spring assembly has a first leaf spring and a second leaf spring mounted to a housing. The rail is slidably mounted to the housing and has a tab and a circular opening. The button is slidably mounted to the rail. The shaving razor cartridge is rotationally mounted within the circular opening of the rail. The linkage has a first end pivotably coupled to a disc and a second end pivotably coupled to the button and is configured to rotate the disc and the shaving razor cartridge. The tab is positioned at a first end of the leaf spring assembly in the retracted position and at a second end of the leaf spring assembly in the open position.

The housing can define an elongated slot dimensioned to receive the tab.

The tab can be circular.

The first leaf spring can have a convex surface facing a convex surface of the second leaf spring.

### BRIEF DESCRIPTION OF THE DRAWINGS

While the specification concludes with claims particularly pointing out and distinctly claiming the subject matter that is regarded as forming the present invention, it is believed that the invention will be better understood from the following description, which is taken in conjunction with the accompanying drawings in which like designations are used to designate substantially identical elements, and in which:

FIG. 1A is a front perspective view of a retractable razor of the present invention in the open position;

FIG. 1B is a front perspective view of the retractable razor of FIG. 1A in the retracted position;

FIG. 2A is a front plan view of the retractable razor of FIG. 1A with the housing cover, rail, and linkage in phantom;

FIG. 2B is a front plan view of the retractable razor of FIG. 1B with the housing cover, rail, and linkage in phantom;

FIG. 3 is a bottom plan view of the retractable razor of FIG. 1A;

FIG. 4 is a front perspective view of the leaf spring assembly of the retractable razor of FIGS. 1A-1B;

FIG. 5A is a front plan view of a first implementation of the leaf spring assembly of FIG. 4 with the cover removed;

FIG. 5B is a front plan view of a second implementation of the leaf spring assembly of FIG. 4 with the cover removed;

FIG. 6 is a front perspective view of the rail of the retractable razor of FIGS. 1A-1B;

FIG. 7 is a rear perspective view of the rail of FIG. 6; and

FIG. 8 is a front perspective view of the shaving razor cartridge of the retractable razor of FIGS. 1A-B.

### DETAILED DESCRIPTION OF THE INVENTION

The examples described herein relate to retractable razors. The example retractable razor herein can be used during travel by retracting the shaving razor cartridge inside the handle of the razor using a simple one-handed sliding motion that does not involve two-hands, multiple motions, or twisting motions to retract the saving razor cartridge. The example retractable razor provides both safety from cuts as well as preventing contamination and damage to the blades of the shaving razor cartridge during travel or storage of the retractable razor, without the need for an additional cap or cover to protect the shaving razor cartridge. The example retractable razor also provides for safe usage at home in environments with children by limiting blade exposure and provides increased storage flexibility for small bathrooms by reducing overall footprint of the retractable razor when retracted.

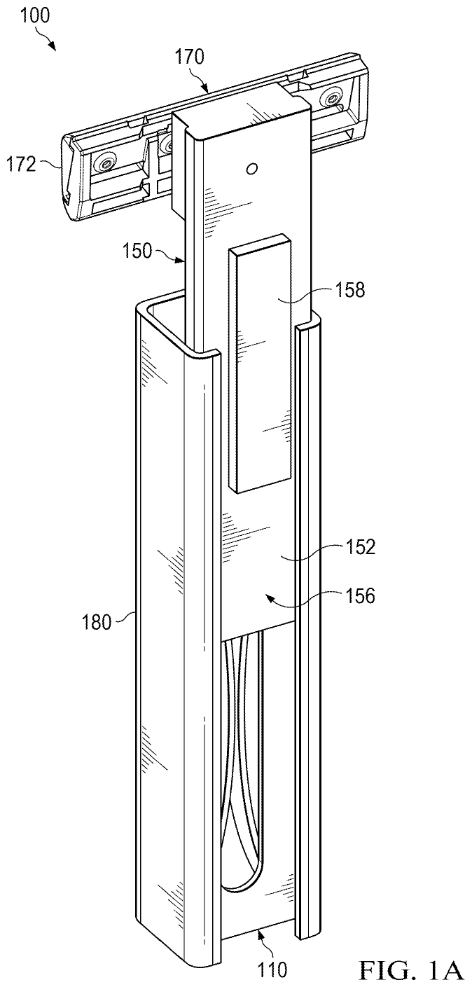

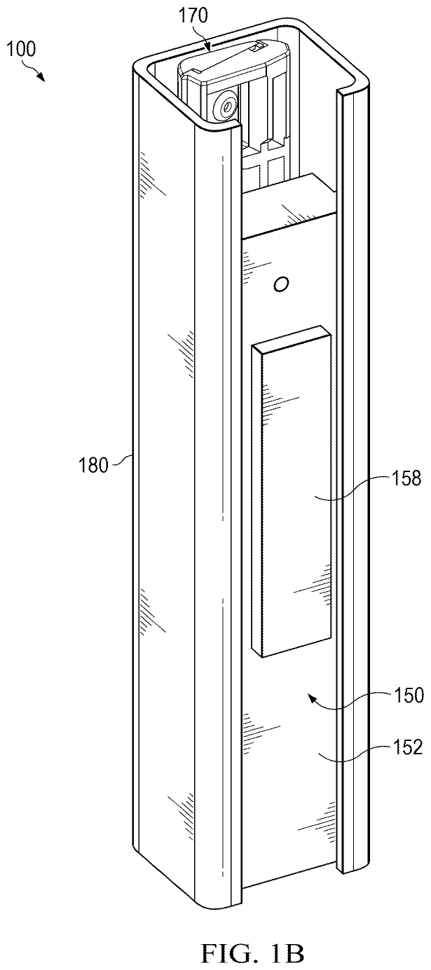

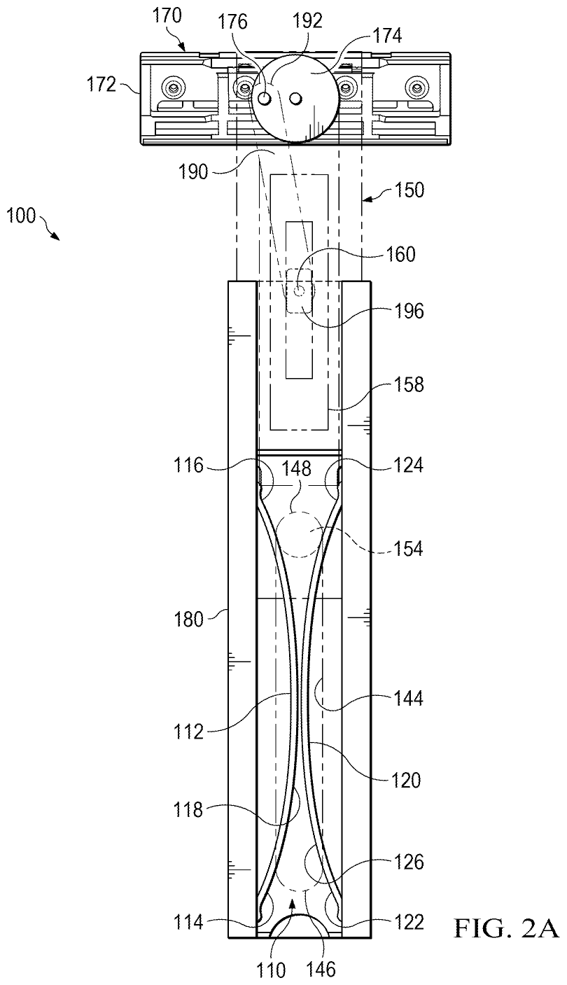

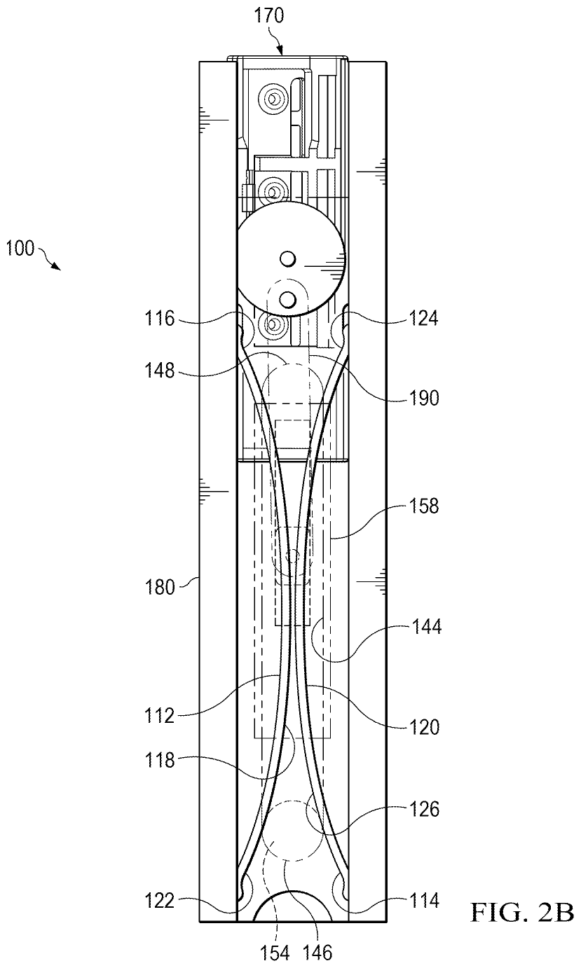

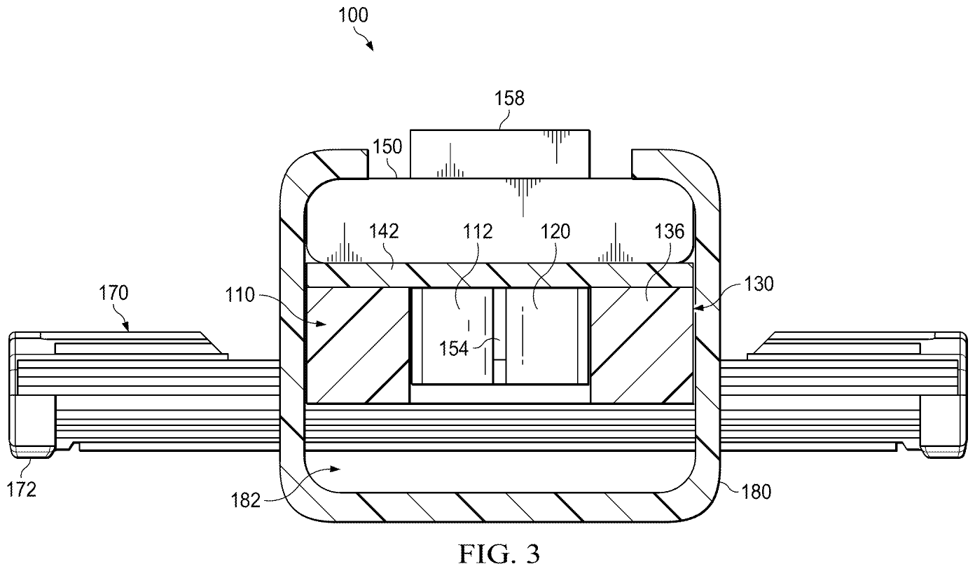

Referring to FIGS. 1A-3, an example retractable razor 100 is shown that is movable between an open position (FIGS. 1A, 2A, and 3), in which a shaving razor cartridge 170 is positioned external of a handle 180 and is positioned generally perpendicular to handle 180, and a retracted position (FIGS. 1B, 2B), in which shaving razor cartridge 170 is rotated generally parallel to handle 180 and is retracted inside of handle 180. In this example, retractable razor 100 generally includes handle 180, a leaf spring assembly 110, a rail 150, and shaving razor cartridge 170.

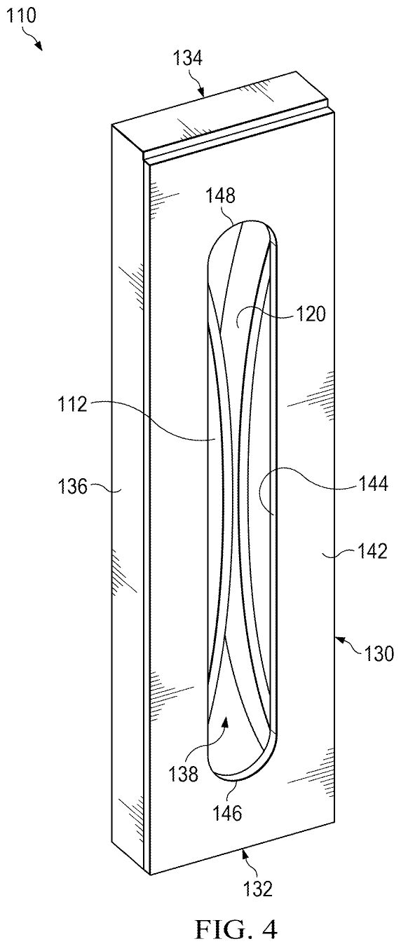

Referring to FIG. 4, leaf spring assembly 110 of retractable razor 100 includes a housing 130 having a main body 136 defining a cavity 138 and a cover 142 secured to main body 136. A first leaf spring 112 and a second leaf spring 120 are positioned within cavity 138 and are mounted to main body 136 of housing 130. Leaf spring assembly 110 can also have a leaf spring cover (not shown) that would hide first leaf spring 112 and second leaf spring 120 when retractable razor 100 is in the open position. To retain retractable razor 100 in the open position (e.g., FIG. 2A) and in the retracted position (e.g., FIG. 2B), while still allowing movement of tab 154 between first leaf spring 112 and second leaf spring 120 when retractable razor 100 is moved between the open position and the retracted position, at least one end of first leaf spring 112 and/or second leaf spring 120 should be movable relative to main body 136 of housing 130.

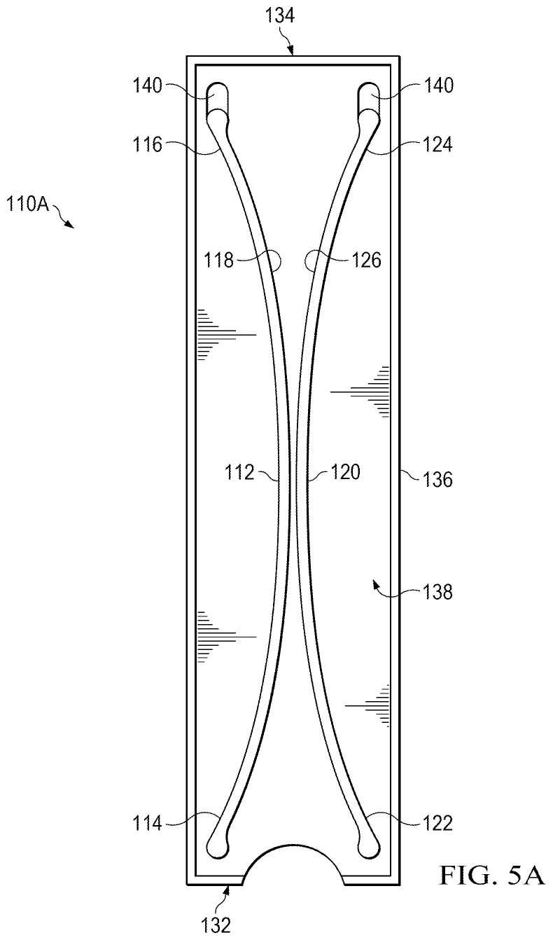

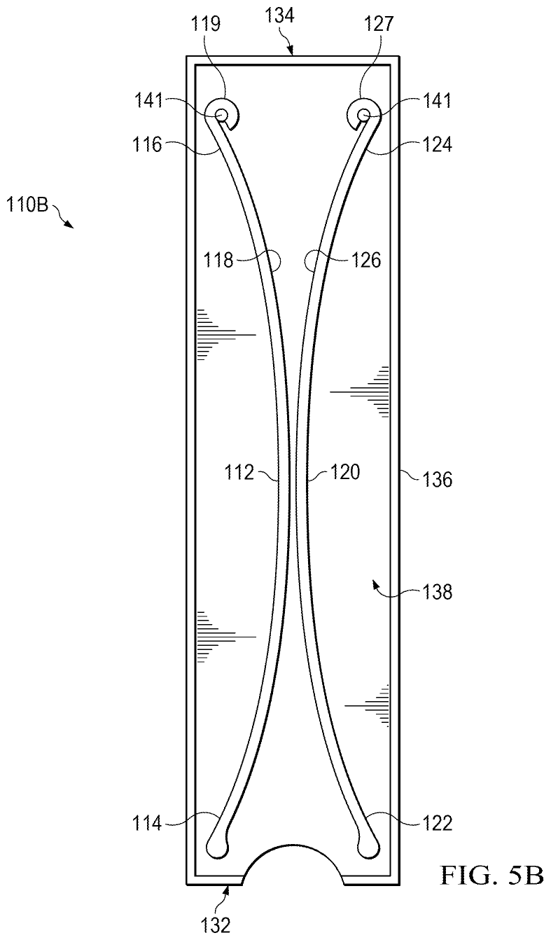

For example, referring to FIG. 5A, in a first implementation of leaf spring assembly 110 (labeled 110A), a first end 114 of first leaf spring 112 and a first end 122 of second leaf spring 120 are each rotatably fixed at a first end 132 of housing 130. In the example shown, protrusions or pins at each of first end 114 of first leaf spring 112 and first end 122 of second leaf spring 120 are positioned within corresponding apertures in main body 136 of housing 130 to fix first leaf spring 112 and second leaf spring 120 to housing 130 and allow first leaf spring 112 and second leaf spring 120 to rotate relative to housing 130 about the protrusions/pins. Alternatively, first end 114 of first leaf spring 112 and first end 122 of second leaf spring 120 could each be fixed at first end 132 of housing 130 without allowing rotation. To allow first leaf spring 112 and second leaf spring 120 to move relative to main body 136 as tab 154 moves between first leaf spring 112 and second leaf spring 120, in leaf spring assembly 110A a second end 116 of first leaf spring 112 and a second end 124 of second leaf spring 120 are each positioned within corresponding elongated recesses 140 in main body 135 of housing 130 at a second end 134 of housing 130. In the example shown, protrusions or pins at each of second end 116 of first leaf spring 112 and second end 124 of second leaf spring 120 are positioned within a corresponding recess 140 in main body 136 such that second end 116 of first leaf spring 112 and a second end 124 of second leaf spring 120 are allowed to translate linearly in a direction generally parallel to a longitudinal axis of housing 130. First leaf spring 112 and second leaf spring 120 are arcuate and first leaf spring 112 has a convex surface 118 that faces a convex surface 126 of second leaf spring 120.

Referring to FIG. 5B, in a second implementation of leaf spring assembly 110 (labeled 110B), first end 114 of first leaf spring 112 and first end 122 of second leaf spring 120 are each rotatably fixed at first end 132 of housing 130, as detailed above for leaf spring assembly 110A. Alternatively, first end 114 of first leaf spring 112 and first end 122 of second leaf spring 120 could each be fixed at first end 132 of housing 130 without allowing rotation. To allow first leaf spring 112 and second leaf spring 120 to move relative to main body 136 as tab 154 moves between first leaf spring 112 and second leaf spring 120, in leaf spring assembly 110B, second end 116 of first leaf spring 112 and second end 124 of second leaf spring 120 could each have an arcuate portion 119, 127 that wraps around a corresponding post 141 extending from main body 136 of housing 130 to allow first leaf spring 112 and second leaf spring 120 to rotate relative to housing 130 about posts 141, rather than translate within recesses 140. First leaf spring 112 and second leaf spring 120 are arcuate and first leaf spring 112 has a convex surface 118 that faces a convex surface 126 of second leaf spring 120.

In other implementations, any combinations of fixed ends (e.g., first end 114 of first leaf spring 112 and first end 122 of second leaf spring 120 in leaf spring assembly 110A), movable ends in recesses (e.g., second end 116 of first leaf spring 112 and second end 124 of second leaf spring 120 in leaf spring assembly 110A), and/or movable ends wrapped around posts (e.g., second end 116 of first leaf spring 112 and second end 124 of second leaf spring 120 in leaf spring assembly 110B) can be used at first end 114 of first leaf spring 112, second end 116 of first leaf spring 112, first end 122 of second leaf spring 120, and/or second end 124 of second leaf spring 120.

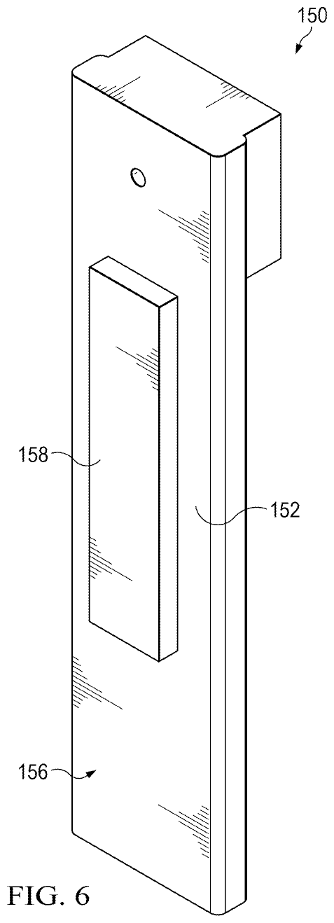

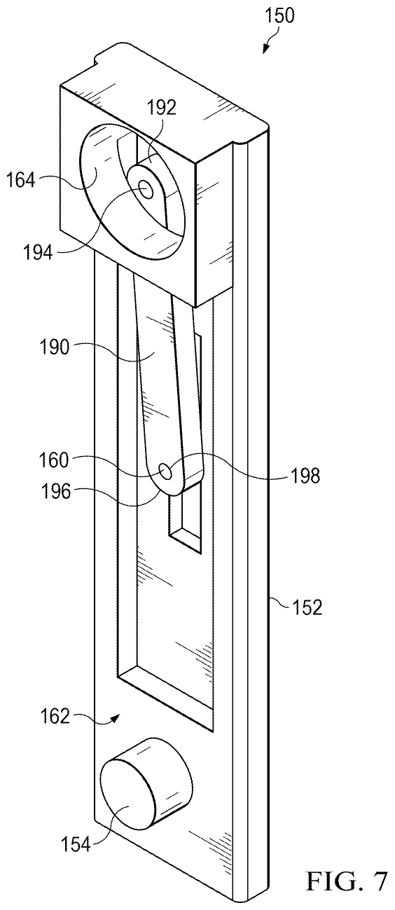

Referring to FIGS. 6-7, rail 150 includes an elongated body 152 and a tab 154 that protrudes from a bottom surface 162 of body 152. Rail 150 is slidably mounted to housing 130 and tab 154 is received in an elongated slot 144 defined in cover 142 of housing 130. As best shown in FIGS. 2A-2B, tab 154 of rail 150 is secured between convex surface 118 of second end 116 of first leaf spring 112, convex surface 126 of second end 124 of second leaf spring 120, and a first end 146 of elongated slot 144 at second end 116 of leaf spring assembly 110 in the open position (FIG. 2A). Similarly, tab 154 is secured between convex surface 118 of first end 114 of first leaf spring 112, convex surface 126 of first end 122 of second leaf spring 120, and a second end 148 of elongated slot 144 at first end 114 of leaf spring assembly 110 in the retracted position (FIG. 2B). Tab 154 is configured to push first leaf spring 112 and second leaf spring 120 apart when retractable razor 100 is moved between the retracted and open positions and, in the example shown, is generally circular. Alternatively, tab 154 could have other shapes, such as a wedge shape, a diamond shape, other shapes with convex and/or concave surfaces, or any other shape that would allow tab 154 to be secured with retractable razor 100 in the open and retracted positions and to push first leaf spring 112 and second leaf spring 120 apart when retractable razor 100 is moved between the retracted and open positions. A top surface 156 of rail 150, opposite bottom surface 162 and tab 154, includes a button 158 that is slidably mounted to rail 150 and configured to receive a digit, such as a thumb or finger, of a user. Button 158 is linearly moveably along a longitudinal axis of rail 150 and could be an external component or integrated into rail 150.

Handle 180 is configured to be grasped by the user and defines a cavity 182 that is configured to receive leaf spring assembly 110 and rail 150, such that leaf spring assembly 110 is fixed within handle 180 and rail 150 is longitudinally slidable within handle 180.

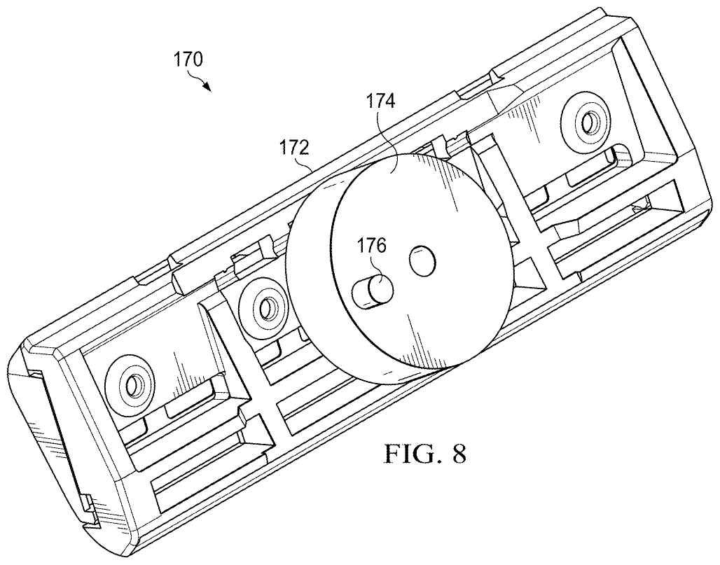

Shaving razor cartridge 170 is rotationally mounted to rail 150 and is configured to move relative to housing 130, handle 180, and rail 150 between the retracted and open positions. Referring to FIG. 8, shaving razor cartridge 170 generally includes a cartridge head 172 that includes one or more blades (not shown) for cutting hair and a disc 174 that extends from a rear surface of cartridge head 172. Disc 174 is positioned with a circular opening 164 defined by rail 150 such that disc 174 of shaving razor cartridge 170 is rotationally mounted within circular opening 164 in rail 150 to allow shaving razor cartridge 170 to rotate relative to rail 150. In the example shown, disc 174 is fixed to shaving razor cartridge 170.

Referring to FIGS. 2A, 2B, and 7, a linkage 190 operably connects button 158 and shaving razor cartridge 170 and is configured to rotate disc 174, and therefore shaving razor cartridge 170, relative to rail 150 between the retracted and open positions. Linkage 190 translates linear motion of button 158 into rotational motion of disc 174 and, therefore, of shaving razor cartridge 170 so that linear movement of button 158 moves shaving razor cartridge between a position with shaving razor cartridge 170 generally perpendicular to rail 150 and a position with shaving razor cartridge 170 generally parallel to rail 150. With button 158 in a forward position (FIG. 2A), shaving razor cartridge 170 is positioned non-parallel to rail 150. With button 158 in a rearward position (FIG. 2B), shaving razor cartridge 170 is positioned parallel to rail 150. Linkage 190 has a first end 192 that is pivotably coupled to disc 174 of shaving razor cartridge 170 and a second end 196 that is pivotably coupled to button 158 on rail 150. In the example shown, first end 192 of linkage 190 includes an aperture 194 that rotatably engages a post 176 on disc 174 of shaving razor cartridge 170 and second end 196 includes an aperture 198 that rotatably engages a post 160 on button 158 of rail 150.

As shown in FIG. 1A, 2A, in the open position, retractable razor 100 is in a position to be used by a user. In the open position, rail 150 extends from handle 180 and tab 154 of rail 150 is captured between convex surface 118 of second end 116 of first leaf spring 112, convex surface 126 of second end 124 of second leaf spring 120, and a first end 146 of elongated slot 144 at second end 116 of leaf spring assembly 110 to keep rail 150 in place and keep retractable razor 100 in the open position during use. Button 158 is also in the forward position, which positions shaving razor cartridge 170 generally perpendicular to rail 150.

To move retractable razor 100 from the open position (FIGS. 1A, 2A) to the retracted position (FIGS. 2A, 2B) a user would move button 158, for example using a thumb or finger, in a linear direction generally along a longitudinal axis of retractable razor 100 from the forward position to a rearward position. Movement of button 158 from the forward to the rearward position pulls linkage 190 downward, as shown in the drawings, which then rotates shaving razor cartridge 170 from a position generally perpendicular to rail 150 to a position generally parallel to rail 150. Once button 158 has reached the rearward position, continued pressure on button 158 in the linear direction will then retract rail 150 and shaving razor cartridge 170 into handle 180. As rail 150 begins to retract into handle 180, tab 154 will push in between and separate first leaf spring 112 and second leaf spring 120. As the user overcomes the force provides by first leaf spring 112 and second leaf spring 120, tab 154 will continue to move between first leaf spring 112 and second leaf spring 120 and rail 150 will continue to retract further into handle 180. Once tab 154 passes a position approximately past a mid-point of first leaf spring 112 and second leaf spring 120, the resistance provided by first leaf spring 112 and second leaf spring attempting to keep retractable razor 100 in the open position will change to a spring force pushing tab 154 towards first end 132 of housing 130 to move retractable razor into the retracted position.

As shown in FIG. 1B, 2B, in the retracted position, retractable razor 100 is in a position where retractable razor 100 can be safely stored. In the retracted position, rail 150 is retracted into handle 180 and tab 154 of rail 150 is captured between convex surface 118 of first end 114 of first leaf spring 112, convex surface 126 of first end 122 of second leaf spring 120, and second end 148 of elongated slot 144 at first end 114 of leaf spring assembly 110 to keep rail 150 in place and keep retractable razor 100 in the retracted position. Button 158 is also in the rearward position, which positions shaving razor cartridge 170 generally parallel to rail 150. To move retractable razor 100 from the retracted position to the open position, the steps described above are performed in a reverse order.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A retractable razor, comprising:
a leaf spring assembly having a first leaf spring and a second leaf spring mounted to a housing;
a rail slidably mounted to the housing, the rail having a tab; and
a shaving razor cartridge rotationally mounted to the rail; wherein
the shaving razor cartridge is configured to move relative to the housing between a retracted position and an open position; and
the tab is positioned at a first end of the leaf spring assembly in the retracted position and at a second end of the leaf spring assembly in the open position.

2. The retractable razor of claim 1, wherein second ends of the first and second leaf springs each have an arcuate portion that wraps around a corresponding post extending from the housing.

3. The retractable razor of claim 1, wherein second ends of the first and second leaf springs are positioned within elongated recesses at a second end of the housing.

4. The retractable razor of claim 1, wherein the tab is circular.

5. The retractable razor of claim 1, wherein a top surface of the rail opposite the tab includes a button configured to receive a digit of a user.

6. The retractable razor of claim 1, wherein the first leaf spring has a convex surface facing a convex surface of the second leaf spring.

7. The retractable razor of claim 1, wherein the housing defines an elongated slot dimensioned to receive the tab.

8. The retractable razor of claim 7, wherein the tab is secured between a first end of the first leaf spring, a first end of the second leaf spring, and a first end of the elongated slot in the housing, in the retracted position.

9. The retractable razor of claim 7, wherein the tab is secured between a second end of the first leaf spring, a second end of the second leaf spring, and a second end of the elongated slot in the housing, in the open position.

10. The retractable razor of claim 1, comprising a handle defining a cavity configured to receive the leaf spring assembly and the rail.

11. The retractable razor of claim 1, wherein the shaving razor cartridge includes a disc positioned within a circular opening defined by the rail.

12. The retractable razor of claim 1, wherein the tab is configured to push the first and second leaf springs apart when moved between the retracted position and the open position.

13. A retractable razor, comprising:
a housing;
a rail slidably mounted to the housing, the rail defining a circular opening;
a button slidably mounted to the rail;
a shaving razor cartridge having a disc rotationally mounted within the circular opening; and
a linkage having a first end pivotably coupled to the disc and a second end pivotably coupled to the button, wherein the linkage is configured to rotate the disc relative to the rail.

14. The retractable razor of claim 13, wherein the disc is fixed to the shaving razor cartridge.

15. The retractable razor of claim 13, wherein the button has a forward position with the shaving razor cartridge positioned non-parallel to the rail.

16. The retractable razor of claim 15, wherein the button has a rearward position with the shaving razor cartridge positioned parallel to the rail.

17. A retractable razor comprising:
a leaf spring assembly having a first leaf spring and a second leaf spring mounted to a housing;
a rail slidably mounted to the housing, the rail having a tab and a circular opening;
a button slidably mounted to the rail;
a shaving razor cartridge rotationally mounted within the circular opening of the rail; and
a linkage having a first end pivotably coupled to a disc and a second end pivotably coupled to the button; wherein
the linkage is configured to rotate the disc and the shaving razor cartridge; and
the tab is positioned at a first end of the leaf spring assembly in a retracted position and at a second end of the leaf spring assembly in an open position.

18. The retractable razor of claim 17, wherein the housing defines an elongated slot dimensioned to receive the tab.

19. The retractable razor of claim 17, wherein the tab is circular.

20. The retractable razor of claim 17, wherein the first leaf spring has a convex surface facing a convex surface of the second leaf spring.
